(19) United States
(12) Patent Application Publication
(10) Pub. No.: US 2014/0372831 A1
(43) Pub. Date: Dec. 18, 2014

(54) MEMORY CONTROLLER OPERATING METHOD FOR READ OPERATIONS IN SYSTEM HAVING NONVOLATILE MEMORY DEVICE

(71) Applicant: SAMSUNG ELECTRONICS CO., LTD., SUWON-SI (KR)

(72) Inventors: SANGYOON OH, SUWON-SI (KR); DONG-MIN KIM, SUWON-SI (KR); YOUNGMOON KIM, SUWON-SI (KR)

(21) Appl. No.: 14/303,646

(22) Filed: Jun. 13, 2014

(30) Foreign Application Priority Data
Jun. 14, 2013 (KR) 10-2013-0068499

(51) Int. Cl. G06F 11/10

(52) U.S. Cl. CPC G06F 11/1076
USPC 714/764

(57) ABSTRACT

A memory controller operating method includes executing a read operation directed to read data including a correctable data unit and an uncorrectable data unit, the uncorrectable data unit containing data that is uncorrectable using a normal error correction operation. The method further including; performing the normal error correction operation on the correctable data unit to generate partial read data, communicating dummy data instead of the uncorrectable data unit along with the partial read data from the memory controller to a host, and performing an enhanced error correction operation on the uncorrectable data unit while at least in part the dummy data and partial data are being communicated from the memory controller to the host.

### CROSS-REFERENCE TO RELATED APPLICATIONS

A claim for priority under 35 U.S.C. §119 is made to Korean Patent Application No. 10-2013-0068499 filed on Jun. 14, 2013, the subject matter of which is hereby incorporated by reference.

### BACKGROUND

The inventive concept relates generally to semiconductor memory systems, and more particularly, to memory controller operating method that control read operations executed by a nonvolatile memory device in a nonvolatile memory system.

Data accuracy and memory system operating speed are common performance tradeoffs. Various error detection and correction approaches have been proposed for use in semiconductor memory systems over the years. Some error correction approaches are very powerful, are capable of correcting data sets including numerous errors, but are slow running and consume considerable system resources. Other error correction approaches are significantly less powerful, are fast running and consume relatively few system resources.

As nonvolatile memory devices have become ever more dense in their data storage capacity and ever more fast in their operating speed, the frequency of data errors has tended to rise. Effective error correction approaches are required in contemporary memory system.

### SUMMARY

One aspect of the inventive concept provides a memory controller operating method, including; controlling execution of a read operation directed to read data stored in a nonvolatile memory device, the read data including a plurality of data units, each of the plurality of data units is identified as one of a correctable data unit and an uncorrectable data unit, wherein the uncorrectable data unit contains data that is uncorrectable using a normal error correction operation, performing the normal error correction operation on at least one correctable data unit of the plurality of data units to generate partial read data, communicating dummy data instead of at least one uncorrectable data unit of the plurality of data units along with the partial read data from the memory controller to a host, and performing an enhanced error correction operation on the at least one uncorrectable data unit while at least in part the dummy data and partial data are being communicated from the memory controller to the host.

One aspect of the inventive concept provides a system including a nonvolatile memory device, and a memory controller configured to control execution of a read operation directed to read data stored in the nonvolatile memory device, wherein the read data includes a plurality of data units, each of the plurality of data units is identified as one of a correctable data unit and an uncorrectable data unit, the data of the uncorrectable data unit being uncorrectable using a normal error correction operation. The memory controller being further configured to perform the normal error correction operation on at least one correctable data unit of the plurality of data units to generate partial read data, communicate dummy data instead of at least one uncorrectable data unit of the plurality of data units along with the partial read data to the host, and perform an enhanced error correction operation on the at least one uncorrectable data unit while at least in part the dummy data and partial data are being communicated from the memory controller to the host.

One aspect of the inventive concept provides an operating method for a memory controller, including; receiving a first command from host identifying a first read operation directed to first read data stored in a nonvolatile memory device, the first read data including a correctable data unit and an uncorrectable data unit, wherein the uncorrectable data unit contains data that is uncorrectable using a normal error correction operation, receiving a second command from the host identifying a second read operation directed to second read data stored in the nonvolatile memory device, performing the normal error correction operation on the correctable data unit of the first read data to generate partial read data, communicating dummy data instead of the uncorrectable data unit along with the partial read data from the memory controller to a host, and performing an enhanced error correction operation on the uncorrectable data unit while at least in part executing the second read operation.

### BRIEF DESCRIPTION OF THE DRAWINGS

FIG. 1 is a block diagram illustrating a system in accordance with an embodiment of the inventive concept.

FIG. 2 is a block diagram further illustrating the memory controller of FIG. 1.

FIG. 3 is a flow chart summarizing an operating method for the memory controllers of FIGS. 1 and 2.

FIGS. 4 and 5 are respective block diagrams further illustrating the operating method FIG. 3.

FIG. 6 is a block diagram illustrating a memory card system in accordance with an application example of the inventive concept.

FIG. 7 is a block diagram illustrating a user system in accordance with an application example of the inventive concept.

FIG. 8 is a block diagram illustrating a mobile system in accordance with an application example of the inventive concept.

### DETAILED DESCRIPTION

Embodiments of the inventive concept will now be described in some additional detail with reference to the accompanying drawings. However, the inventive concept may be embodied in many different forms and should not be construed as being limited to only the illustrated embodiments. Rather, these embodiments are provided as examples so that this disclosure will be thorough and complete, and will fully convey the inventive concept to one of ordinary skill in the art. Accordingly, known processes, elements, and techniques may not be described with respect to some of the embodiments of the inventive concept. Unless otherwise noted, like reference numbers and labels denote like or similar elements throughout the drawings and written description.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Memory controllers in accordance with certain embodiments of the inventive concept are generally capable of controlling the execution of write (or program) operations that store “write data” in nonvolatile memory device(s) and controlling the execution of read operations that retrieve data (as “read data”) that has been previously stored in the nonvolatile memory device(s). Those skilled in the art will understand that such memory controller usually operate in response to commands received from a host. It is also well understood that memory controllers and associated nonvolatile memory devices routinely incorporate error detection and/or correction capabilities that (1) derive error correction code (ECC) from the write data; (2) store the ECC in the nonvolatile memory as part of programming the write data in the nonvolatile memory device; (3) retrieve the ECC together with corresponding read data retrieved from the nonvolatile memory device and (4) decode the ECC to detect and correct one or more data error in the read data before the read data is returned to (e.g.,) the host.

As is further understood, a range of conventionally understood error detection and/or correction techniques may be implemented using hardware, firmware and/or software components within a “memory system” comprising at least a memory controller and associated nonvolatile memory device(s). Yet, all error correction techniques have a defined error correction range. That is, assuming that a normal error correction technique is capable of detecting and correcting ‘k’ bits errors is a given block of data, then ‘k+1’ or more bit errors would be deemed functionally uncorrectable by the normal error correction technique. In this context, the term “normal” is used to indicate an error correction technique that has been selected for use during the execution of normal (i.e., routinely executed) read and/or write operations.

Thus, many conventionally understood error detection and/or correction techniques have the ability to differentiate between sets of “correctable” bits errors and sets of “uncorrectable” bit errors (i.e., sets or types of errors identified in retrieved read that data that exceed the error correction capabilities of the error correction technique. In certain embodiments of the inventive concept, the detection of uncorrectable error(s) will cause a memory controller to generate an “uncorrectable error correction code (UECC) error” in relation to read data identified by a read operation or the normal error correction technique. Under these conditions, the memory controller may communicate “dummy read data” to the host in response to the read operation instead of the UECC read data actually obtained from the nonvolatile memory device.

Then, using an “enhanced error correction technique” having error correction capabilities that exceed the normal error correction technique, the memory controller may correct the errors in the UECC data and thereafter communicate the corrected read data to the host. That is, an enhanced error correction operation may be specifically performed in relation to UECC data identified by the normal error correction technique during read operations, thereby improving memory controller performance. It should be noted in this context that one or more enhanced error correction operations capable of being executed by the memory controller will generally require more execution time and/or resources that the one or more normal error correction operations used by the memory controller. Hence, routine read operations may be handled using relatively modest levels of resources and/or computational time while difficult read operations returning highly errant read data may be handled using higher levels of resources and/or computational time.

Figure (FIG.) 1 is a block diagram generally illustrating in relevant portion a system 100 in accordance with certain embodiments of the inventive concept. The system 100 may take the form of many different computational systems, such as an ultra mobile PC (UMPC), workstation, net-book, personal digital assistants (PDA), portable computer, web tablet, tablet computer, wireless phone, mobile phone, smart phone, e-book, portable multimedia player (PMP), portable game machine, navigation device, black box, digital camera, digital multimedia broadcasting (DMB) player, three-dimensional television, smart television, digital audio recorder, digital audio player, digital picture recorder, digital picture player, etc.

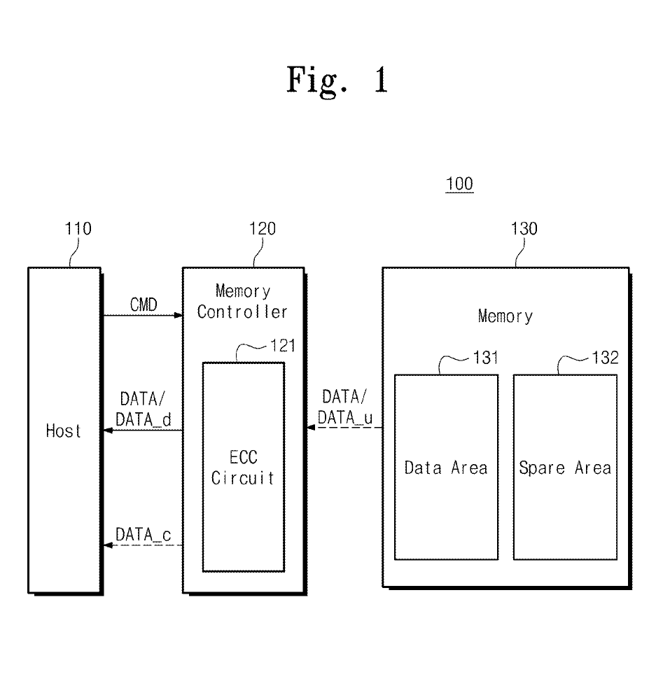

As illustrated by the example of FIG. 1, the user system 100 comprises a host 110, a memory controller 120, and a nonvolatile memory device 130. Here, the memory controller 120 and nonvolatile memory device 130 may be implemented as a single chip, a chip set, a memory system module, etc.

The host 110 may exchange data with the memory controller 120 using one or more data communication protocols, such as a universal serial bus (USB) protocol, multimedia card (MMC) protocol, PCI protocol, serial ATA protocol, parallel ATA protocol, small computer system interface (SCSI) protocol, enhanced small disk interface (ESDI) protocol, integrated drive electronics (IDE) protocol, mobile industry processor interface (MIPI) protocol, etc.

Using a selected protocol, the host 110 is assumed to communicate a write command (CMD) and corresponding write data (DATA) to the memory controller 120 which initiates execution of a program operation whereby the write data together with its corresponding ECC is stored in the nonvolatile memory device 130. Data may be retrieved when the host 110 communicates a read command (CMD) that identifies certain read data (DATA) to the memory controller 120. In response to the read command, the memory controller 120 controls execution of a read operation by the nonvolatile memory device 130 that retrieves the identified read data together with its corresponding ECC.

Thus, the nonvolatile memory device 130 is assumed to execute read, program and erase operations under the control of the memory controller 120 and in response to commands received by the memory controller 120 from the host 110. The nonvolatile memory device 130 may include one or more types of semiconductor memory device, such as a NAND flash memory, NOR flash memory, magnetic random access memory (MRAM), phase random access memory (PRAM), resistive random access memory (RRAM), etc.

The memory controller 120 includes an error correction code (ECC) circuit 121. The ECC circuit 121 is capable of computationally performing at least one normal error correction operation capable of detecting and/or correcting up to ‘k’ bit errors in a set read data (DATA) of defined size retrieved from the nonvolatile memory device 130. In certain embodiments of the inventive concept, the ECC circuit 121 operates in relation to ECC code that has been stored in a “spare area” 132 of the nonvolatile memory device 130 as distinguished from a “data area” 131 used to store data. Here, one or more spare area(s) 132 and one or more spare area(s) provided by the nonvolatile memory device 130 may take variously forms or arrangements within the constituent memory cell array(s) of the nonvolatile memory device 130. Thus, it is assumed that the normal error correction operation performed by the memory controller 120 is capable of correcting 0 to k errant bits of data in the retrieved read data to thereby provide appropriately corrected read data to the host 110 in response to a read command.

However, should the number of errant bits in the read data retrieved form the nonvolatile memory device 130 exceed ‘k’, (i.e., the detected errors exceed the error correction capacity of the normal error correction operation), then the ECC circuit 121 may not normally correct such errors using the available ECC and the normal error correction operation. Accordingly, an uncorrectable error correction code (UECC) error is identified in relation to uncorrectable (or UECC) read data (“DATA_u”).

In a case where UECC data is retrieved from the nonvolatile memory device 130, the memory controller 120 will perform an enhanced error correction operation (or “UECC error correction operation”). Here, the enhanced error correction operation will be different and more powerful than the normal error correction operation. In certain embodiments of the inventive concept, both the normal and enhanced error correction operations may be performed by the ECC circuit 121, albeit the execution of the enhanced error correction operation will require more time.

For example in certain embodiments of the inventive concept, the memory controller 120 upon receiving indication of UECC data may re-read the identified read data from the nonvolatile memory device, perhaps using a different read technique than that usually used in normal read operations. Thereafter, the memory controller 120 may seek to correct the re-read UECC data using the enhanced error correction operation.

It should be noted here, that execution of the enhanced error correction operation by the memory controller 120 may be performed under the control of software resources available to the memory controller 120, but not normally accessed during execution of the normal error correction operation.

In response to a read command provided by the host 110 that results in the identification of UECC data from the nonvolatile memory device 130, the memory controller 120 may communicate dummy data (DATA_d) to the host 110 before completion of the execution of the enhanced error correction operation on the UECC data. It should be noted here that read data requested by the host 110 may be stored and provided in relation to multiple identifiable data units (e.g., pages, blocks, sets, groups, etc.). Thus, in certain embodiments of the inventive concept, UECC data may be understood as including one or more “correctable data units” and one or more “uncorrectable data units”, where the correctable data unit(s) may be normally processed (e.g., read, error-corrected, and returned to the host 110 according to normally used operations) while the uncorrectable data unit(s) required extra processing (e.g., use of the enhanced error correction operation, use of a re-read operation, etc.). Thus, by returning dummy data to the host 110 for only the uncorrectable data units of the requested read data, the memory controller 120 may in a normal course of data processing return “partial read data” to the host 110 in response to a read command while yet performing the extra data processing required to correct the uncorrectable data unit(s) using at least an enhanced error correction operation. Later, the corrected UECC data (DATA_c) may be returned to the host 110 after the partial read data has been returned.

In certain approaches, the dummy data provided by the memory controller 120 to the host 110 may be the same UECC data obtained from the nonvolatile memory device. Alternately, the dummy data may be defined to have a predetermined data pattern (e.g., all bits of the dummy data will have a same value, or a random pattern may be used).

The foregoing example embodiments compare very favorably in performance outcome with conventional systems. In a case where UECC data is detected by a conventional memory controller, the memory controller will halt normal data processing, perform an enhanced error correction operation on the UECC data, communicate the corrected UECC data to the host, and then resume normal operations. In contrast, according to certain embodiments of the inventive concept, once UECC data is detected, a memory controller will communicate all correctable data units of the read data along with dummy data for any uncorrectable data units before completion of the execution of an enhanced error correction operation for the UECC data. Accordingly, the overall transfer of data between the memory controller and host is improved by simultaneously (at least in part) providing at least partial read data to the host while executing the enhanced error correction operation.

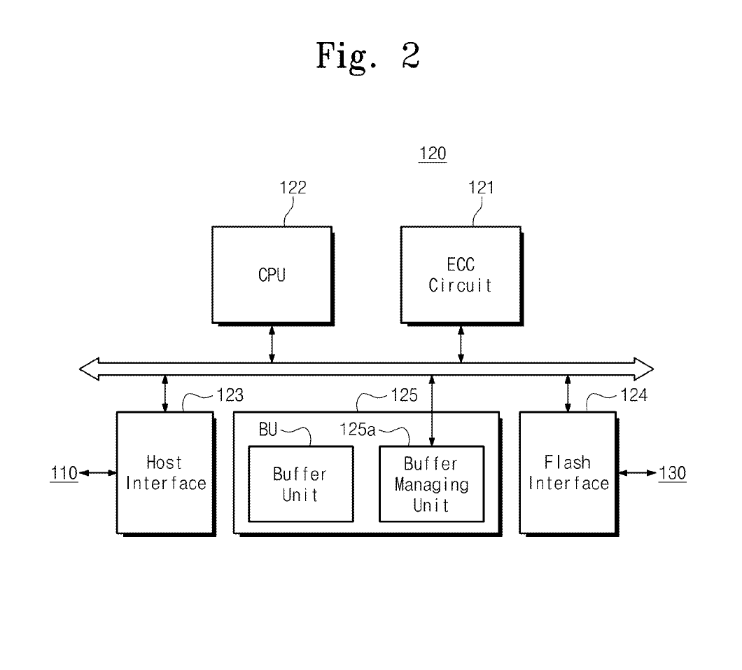

FIG. 2 is a block diagram further illustrating the memory controller of FIG. 1. Referring to FIG. 2, the memory controller 120 comprises in relevant portion the ECC circuit 121, a CPU 122, a host interface 123, a flash interface 124 and a buffer memory 125.

As described above, the ECC circuit 121 is generally capable of executing both normal and enhanced error correction operations that detect and/or correct error(s) included in read data obtained form the nonvolatile memory device 130 in relation to corresponding ECC also stored in the nonvolatile memory device.

The CPU 122 may be used to analyze and processes command(s), control signal(s) and/or write data received from the host 110. The CPU 122 respectively controls the overall operation of the host 110 and nonvolatile memory device 130 through the host interface 123 and flash interface 124. The CPU 122 may in certain embodiments control the nonvolatile memory device 130 according to firmware configured to drive the operation of the nonvolatile memory device 130.

The host interface 123 provides an interface between the memory controller 120 and host 110. The host interface 123 may be used to communicate with the host 110 using an interface such as a USB (universal serial bus), a SCSI (small computer small interface), a PCI-E (PCI-express), an ATA (advanced technology attachment), a parallel-ATA, a serial-ATA, a serial attached SCSI (SAS), a MIPI (mobile industry processor interface), etc.

The use of the flash interface 124 presupposes the use of one or more flash memory devices for the nonvolatile memory device 130. The flash interface 124 may be used to randomly scatter write data as it is programmed in the data area 131 as controlled by the operation of the buffer memory 125. The flash interface 124 may also be used to communicate read data obtained from the flash memory device 130 to buffer memory 125.

The buffer memory 125 may be used to temporarily store write data received from the host 110 or read data obtained from the nonvolatile memory device 130. The buffer memory 125 may be used to store meta data or cache data to be stored in the nonvolatile memory device 130. The buffer memory 125 illustrated in FIG. 2 includes a plurality of buffer units BU and a buffer managing unit 125a. The buffer units BU may be allocated to store write data or read data. Allocation information for the buffer units BU may be stored in a buffer table.

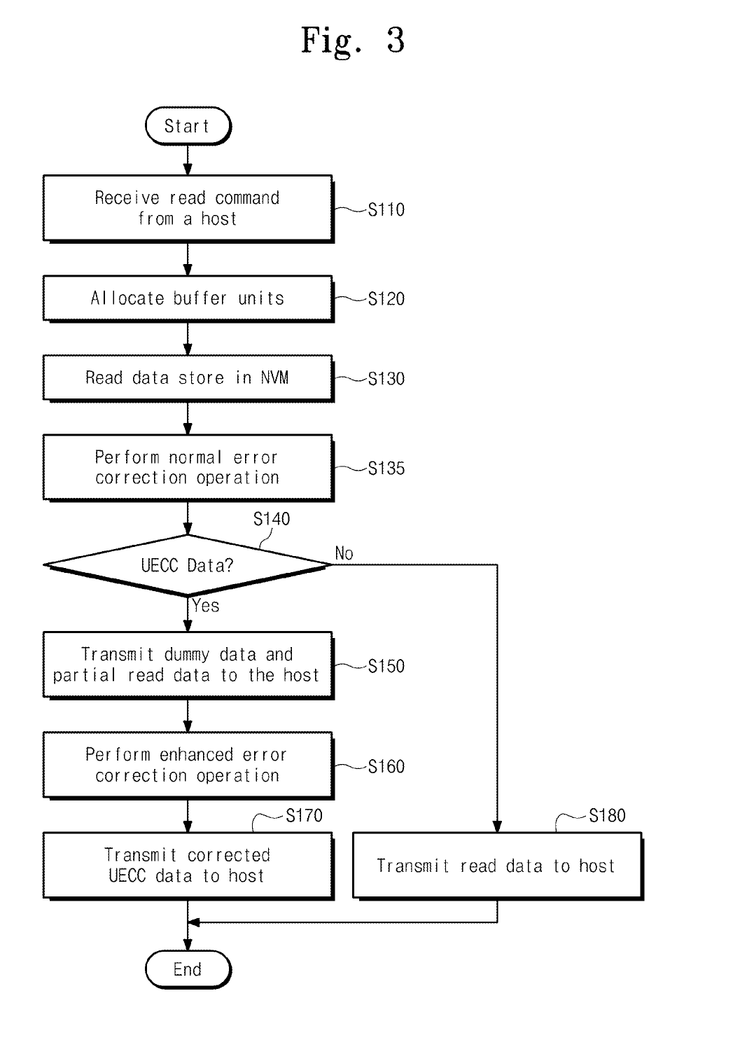

FIG. 3 is a flow chart summarizing in one example a method of operating a memory controller such as the one shown in FIG. 1. The memory controller 120 receives a read command (CMD) from the host 110 (S110). Here, the read command is assumed to identify read data provided in data units DATA_1˜DATA_n that are respectively stored in the nonvolatile memory device 130.

Thus, the memory controller 120 allocates corresponding buffer units (BU1-BUn) of the buffer memory 125 to receive read data DATA_1˜DATA_n to be obtained from the nonvolatile memory device 130 (S120). For example, the memory controller 120 may allocate some or all of available buffer units in response to the read command, or address(es) associated with the read command. The memory controller 120 may store information regarding the allocated buffer units in a buffer table stored (e.g.,) in a cache memory of the memory controller 120.

Now, the memory controller 120 causes the execution of a normal read operation directed to the read data DATA_1˜DATA_n stored in the nonvolatile memory device 130 (S130). Consistent with the illustrated example of FIG. 3, it is assumed that each one of the respective data units of the read data (e.g., DATA_1˜DATA_n) is stored in a corresponding one of the allocated buffer units BU1-BUn).

The memory controller 120 performs a normal error correction operation for detecting and correcting errors of the read data. (S135) For example, the memory controller 120 includes the ECC circuit 121 executing the normal error correction operation. The ECC circuit 121 may be used to detect data error(s) in each data unit of the read data. Where the detected errors for a given data unit are correctable, the data unit may be immediately corrected using the normal error correction operation, and thereafter the data unit may be deemed a corrected read data. Alternatively, the data unit which is corrected error(s) may be stored in the allocated buffer units. However, where the detected errors for a given data unit are uncorrectable, the data unit will not be corrected using the normal error correction operation, and thereafter the data unit will be deemed an uncorrectable error read data (UECC data). In embodiments of the inventive concept, the memory controller 120 may perform the normal error correction operation on correctable data unit to generate partial read data. The partial read data means correctable data units which are corrected errors by the normal error correction operation.

If none of the data units of the read data are identified as uncorrectable data units, then the entire set of read data may be returned to the host 110 in response to the read command (S180).

Alternately, a collection of the corrected data units along with dummy data for any uncorrectable data unit(s) are returned to the host 110 in response to the read command as partial read data (S150). Here, the return of partial read data may be accomplished during some portion of the time required to correct the uncorrectable data unit(s) using the enhanced error correction operation (S160). Once the uncorrectable data unit(s) have been corrected using the enhanced error correction operation (S160), the resulting corrected UECC data may be communicated to the host 110 (S170).

In certain embodiments of the inventive concept, the corrected read data may be sequentially communicated from the memory controller 120 to the host 110 according to defined data units (DATA_1˜DATA_n) using a serial data communication protocol and competent interface.

In certain embodiments of the inventive concept, the memory controller 120 may be used to store information regarding the UECC data in a buffer table. The UECC data information may include offset and size information related to a particular buffer unit currently storing the UECC data. As has been previously noted, the dummy data may be the actual UECC data, or some equivalent set of data having a predetermined pattern.

In certain embodiments of the inventive concept, the memory controller 120 may be used to overwrite the corrected UECC data (DATA_c) into a buffer unit previously used to store the dummy data (DATA_d).

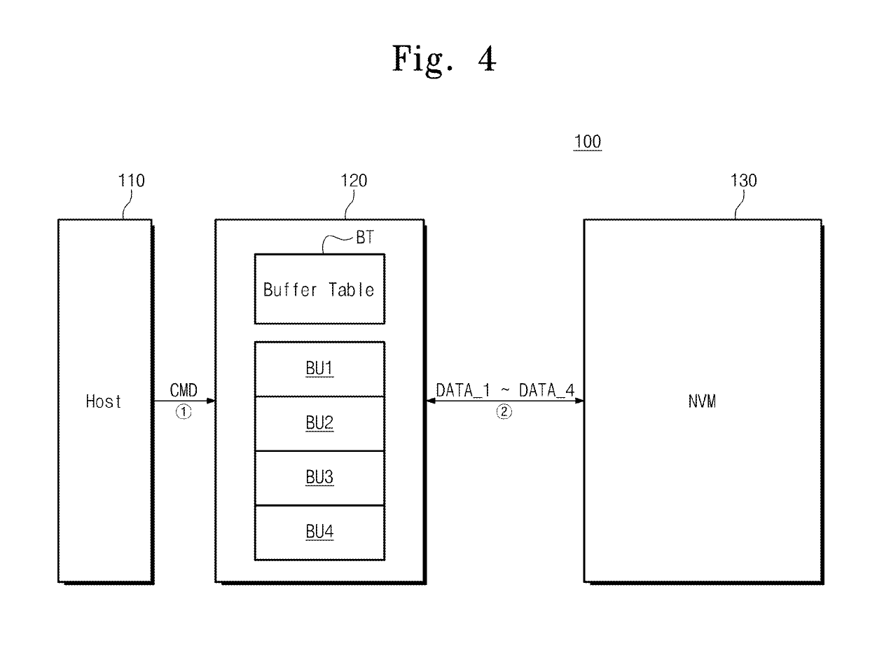

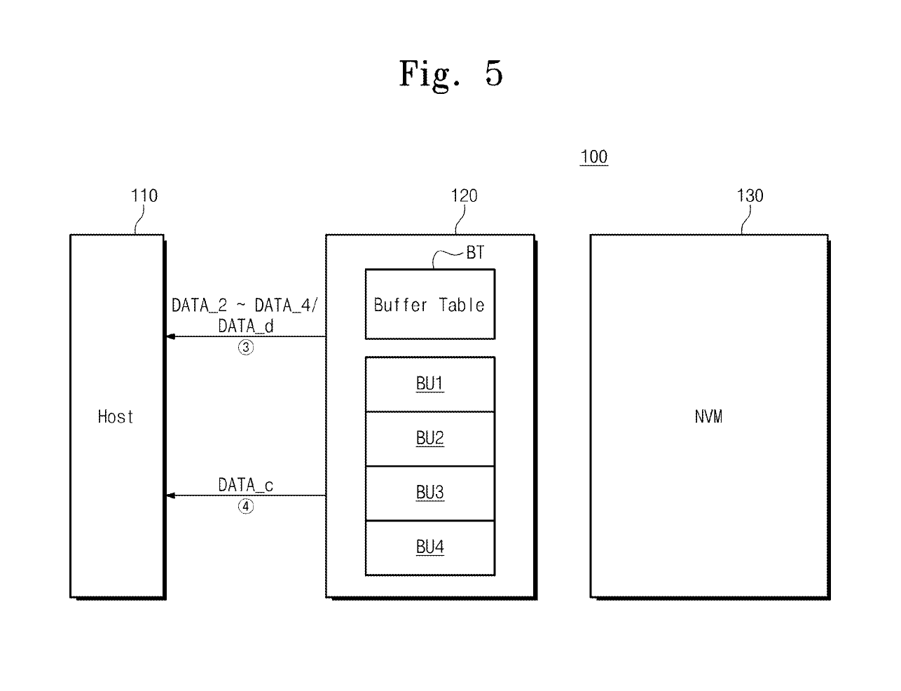

FIGS. 4 and 5 are respective block diagrams further illustrating the exemplary operating method of FIG. 4 as executed by the memory controller of FIGS. 1, 2, and 3. For explanation purposes, it will be assumed that the nonvolatile memory device 130 reads only first, second, third and fourth read data units (DATA_1˜DATA_4). That is, the memory controller 120, in response to a read command, reads first through fourth read data units from the nonvolatile memory device 130, and ultimately communicates corrected versions of the first through fourth read data units to the host 110.

Referring collectively to FIGS. 4 and 5, the system 100 is again assumed to include the host 110, memory controller 120 and nonvolatile memory device 130. The memory controller 120 is assumed to have allocated buffer units BU1˜BU4 according to a buffer table BT.

In FIG. 4, the host 110 is assumed to transmit a command (CMD) to the memory controller 120 \textcircled{1}, where the command indicates a read operation directed of the first through fourth read data units (DATA_1˜DATA_4).

In response to the read command, the memory controller 120 allocates first through fourth buffer units BU1˜BU4 to respectively receive the first through fourth read data DATA_1˜DATA_4. Hence, the memory controller 120 is able to store the requested read data in the allocated first through fourth buffer units BU1˜BU4 as controlled by allocation information stored in the buffer table BT. The allocation information may include offset and size information for the first through fourth buffer units BU1˜BU4. Then, the memory controller 120 may read the first through fourth read data units (DATA_1˜DATA_4) from the nonvolatile memory device 130 \textcircled{2}.

Referring now to FIG. 5, the memory controller 120 may be used to detect and/or correct error(s) apparent in the first through fourth read data units. For example, the ECC circuit 121 of FIG. 2 may be used to detect and correct errors identified in the first through fourth read data units (DATA_1˜DATA_4). Here, it assumed that a first read data (DATA1) is UECC data (DATA_u).

As a result, the memory controller 120 must perform an enhanced error correction operation in order to correct the UECC data. However, the second, third and fourth read data units (DATA2, DATA3 and DATA4) are assumed to be correctable data units that may be processed using the normal error correction operation. Thus, the memory controller 120 will communicate dummy data DATA_d instead of the UECC data (DATA_1) to the host 110, along with corrected read data units DATA2˜DATA4 using (e.g.,) a serial interface \textcircled{3}.

Upon completion of the execution of the enhanced error correction operation in relation to the UECC data, the memory controller 120 will communicate a corrected version of the UECC data (DATA_c) to the host 110 \textcircled{4}.

A data transmission between the memory controller 120 and the host 110 and between the memory controller 120 and the nonvolatile memory device 130 may be performed based on direct memory access (DMA) operations.

According to the foregoing illustrated embodiments of the inventive concept, in a case where UECC data is detected, the memory controller 120 may communicate dummy data (DATA_d) instead of a uncorrectable data unit, along with all normally correctable data units of requested read data. Then, the memory controller 120 may perform an enhanced error correction operation in relation to the uncorrectable data unit(s) while (wholly or in part) the resulting partial read data, plus dummy data for the uncorrectable data nit(s) are collectively being communicated to the host. Thereafter, the memory controller 120 may complete the enhanced error correction operation for the UECC data, and communicate a corrected version of the UECC data. In this manner, the memory controller 120 communicates at least partial read data during the execution of an enhanced error correction operation, thereby improving system performance.

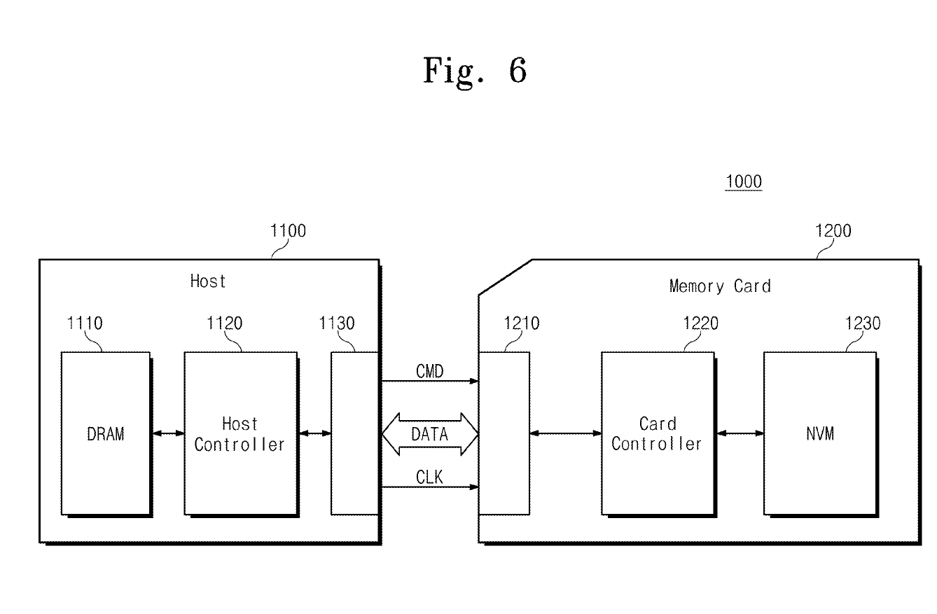

FIG. 6 is a block diagram illustrating a memory card system in accordance with an application example of the inventive concept. A memory card system 1000 includes a host 1100 and a memory card 1200. The host 1100 includes a DRAM 1110, a host controller 1120 and a host connection unit 1130. The memory card 1200 includes a card connection unit 1210, a card controller 1220 and a flash memory device 1230.

The host 1100 can write data in the memory card 1200 or read data stored in the memory card 1200. The host controller 1120 can transmit a command (e.g., a read command), a clock signal CLK generated from a clock generator (not shown) in the host 110 and data (DATA) to the memory card 1200 through the host connection unit 1130. The card controller 1220 can read data stored in the flash memory device 1230 in response to a read command received through the card connection unit 1210. The card controller 1220 can be embodied based on the constitution of the memory controller 120 described with reference to FIGS. 1 through 5.

The host 1100 and the memory card 1200 can transmit and receive data on the basis of a serial interface. The host 1100 and the memory card 1200 can communicate with each other on the basis of M-PHY interface.

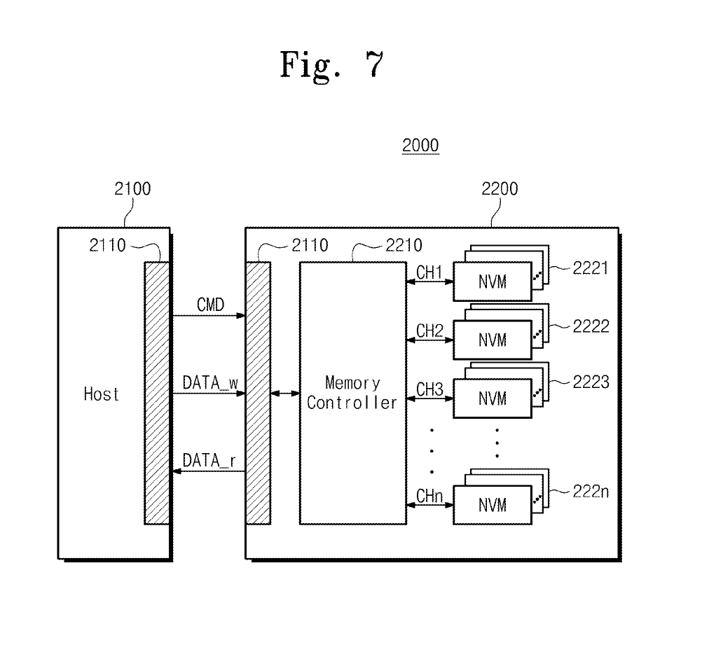

FIG. 7 is a block diagram illustrating a user system in accordance with an application example of the inventive concept. Referring to FIG. 7, a user system 2000 includes a host 2100 and a memory module 2200. The host 2100 can transmit and receive a signal such as a command CMD, write data (DATA_w) and read data (DATA_r) to and from the memory module 2200. The host 2100 can communicate with the memory module 2200 on the basis of a predetermined interface 2110. For example, the host 2100 can communicate with the memory module 2200 on the basis of a serial interface. The host 2100 can also communicate with the memory module 2200 on the basis of M-PHY interface.

The memory module 2200 includes a memory controller 2210 and a plurality of nonvolatile memory devices 2221˜222n. The memory controller 2210 can control the nonvolatile memory devices 2221˜222n in response to a command CMD received from the host 2100. The memory controller 2210 can be provided based on the memory controller described with reference to FIGS. 1 through 6.

The memory controller 2210 is connected to the nonvolatile memory devices 2221˜222n through a plurality of channels CH1˜CHn. The memory controller 2210 can control the nonvolatile memory devices 2221˜222n respectively. The memory module 2200 can be provided by a universal flash storage (UFS).

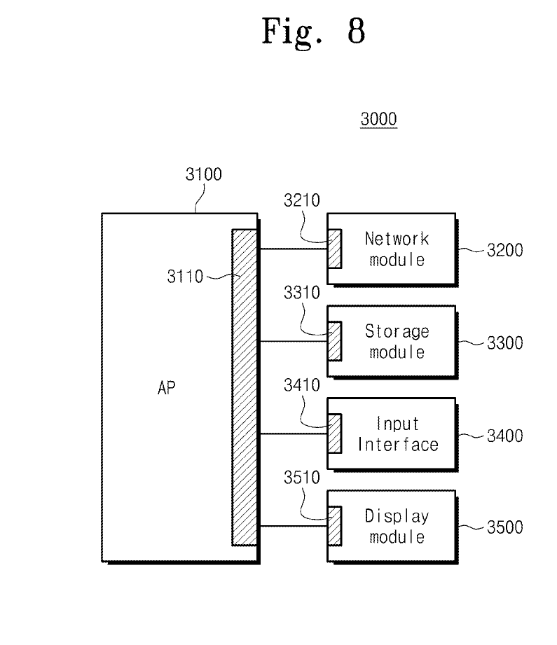

FIG. 8 is a block diagram illustrating a mobile system in accordance with an application example of the inventive concept. A mobile system 3000 may be one of portable wireless devices such as a cellular phone, a smart phone, a tablet PC, a digital camera, an E-book, etc.

Referring to FIG. 8, a mobile system 3000 may include an application processor (AP) 3100, a network module 3200, a storage module 3300, an input interface 3400 and a display module 3500.

The AP 3100 can drive constituent elements included in the mobile system 3000, an operating system (OS), etc. The AP 3100 may include a graphic engine, controllers controlling constituent elements included in the mobile system 3000, and interfaces.

The network module 3200 can communicate with external devices. The network modules 3200 can support a wireless communication such as a code division multiple access (CDMA), a global system for mobile communication (GSM), a wideband CDMA (WCDMA), a CDMA-200, a time division multiple access (TDMA), a long term evolution (LTE), a Wimax, a WLAN, an UWB, a Bluetooth, a WI-DI, etc.

The storage module 3300 can store data. The storage module 3300 can store data received from the outside. The storage module 3300 can transmit data stored in the storage module 3300 to the AP 3100. The storage module 3300 may be embodied by a semiconductor memory device such as a dynamic random access memory (DRAM), a synchronous DRAM (SDRAM), a static RAM (SRAM), a double data rate SDRAM (DDR SDRAM), a DDR2 SDRAM, a DDR3 SDRAM, a phase-change RAM (PRAM), a magnetic RAM (MRAM), a resistive RAM (RRAM), a NAND flash, a NOR flash, etc. The storage module 3300 may include the memory controller and the nonvolatile memory device described with reference to FIGS. 1 through 6. The storage module 3300 operates based on the operation method described with reference to FIGS. 1 through 6. The storage module 3300 may be provided by a universal flash storage.

The input interface 3400 provides an interface inputting data or a command into the mobile system 3000. The input interface 3400 may include a camera, a touch screen, a motion recognition module, a mike, etc. The display module 3500 can output an image, a graphic, etc. under the control of the AP 3100.

The AP 3100 and the storage module 3300 can communicated with each other on the basis of a single interface. For example, the AP 3100 can be connected to the storage module 3300 through host interfaces 3110 and 3310. The AP 3100, the network module 3200, the storage module 3300, the input interface 3400 and the display module 3500 can be connected to one another through interfaces 3110, 3210, 3310, 3410 and 3510. The interfaces 3110, 3210, 3310, 3410 and 3510 may be provided based on a M-PHY interface. The AP 3100 can control constituent elements included in the mobile system 3000 on the basis of a single interface.

According to certain embodiments of the inventive concept, in a case where an UECC error occurs during a read operation directed to memory cells of a nonvolatile memory device, a memory controller may communicate dummy data for the UECC data to a host along with corrected, partial read data. Thus, the memory controller may be enabled to communicate read data associated with a next subsequent read operation to the host before an enhanced error correction operation is completed. That is, the memory controller may simultaneously, in whole or in part, control the transmission of (partial+dummy) read data to a host while executing an enhanced error correction operation. After the enhanced error correction operation is completed, the memory controller may transmits a corrected version of the UECC data to the host. Accordingly, reliability of read data is guaranteed and a nonvolatile memory system having improved performance is provided.

According to certain embodiments of the inventive concept, in a case where UECC data is detected during a first read operation, a memory controller may communicate dummy data to a host during execution of the enhanced error correction operation directed to the UECC data. Thus, the memory controller may execute the enhanced error correction operation while also executing a second (next subsequent) read operation, thereby improving memory controller and memory system performance.

The above-disclosed subject matter is to be considered illustrative, and not restrictive, and the appended claims are intended to cover all such modifications, enhancements, and other embodiments, which fall within the scope of the following claims. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A memory controller operating method, comprising:
controlling execution of a read operation directed to read data stored in a nonvolatile memory device, the read data including a plurality of data units, each of the plurality of the data units is identified as one of a correctable data unit and an uncorrectable data unit, wherein the uncorrectable data unit contains data that is uncorrectable using a normal error correction operation;
performing the normal error correction operation on at least one correctable data unit of the plurality of data units to generate partial read data;
communicating dummy data instead of at least one uncorrectable data unit of the plurality of data units along with the partial read data from the memory controller to a host; and
performing an enhanced error correction operation on the uncorrectable data unit while at least in part the dummy data and partial data are being communicated from the memory controller to the host.

2. The method of claim 1, further comprising:
communicating a corrected version of the at least one uncorrectable data unit from the memory controller to the host upon completion of the enhanced error correction operation.

3. The method of claim 2, wherein the dummy data is data selected from a group consisting of; data of the at least one uncorrectable read unit, data having a random pattern, and data having a predetermined pattern.

4. The method of claim 1 further comprising:
receiving a read command from the host in the memory controller that initiates the read operation and identifies the read data as stored in the nonvolatile memory device.

5. The method of claim 4, further comprising:
allocating buffer units in a buffer memory of the memory controller to receive the plurality of data units of the read data; and
storing each one of the plurality of data units in a respective one of the allocated buffer units.

6. The method of claim 5, further comprising:
on a data unit-by-data unit basis for the plurality of data units stored in the allocated buffer units, using an error correction coding (ECC) circuit to identify whether data associated with each one of the plurality of data units is correctable data.

7. The method of claim 6, wherein the identifying of whether data associated with each one of the plurality of data units is correctable data is performed using the normal error correction operation as executed by the ECC circuit.

8. The method of claim 2, further comprising:
allocating buffer units in a buffer memory of the memory controller to receive the plurality of data units of the read data;
storing each one of the plurality of data units in a respective one of the allocated buffer units, wherein at least one of the buffers stores the at least one uncorrectable data unit,
wherein the communicating of the corrected version of the at least one uncorrectable data unit from the memory controller to the host upon completion of the enhanced error correction operation is performed by overwriting the at least one uncorrectable data unit stored in the at least one buffer unit with the corrected version of the at least one uncorrectable data unit.

9. The method of claim 8 further comprising:
updating a buffer unit information based on the allocation of the buffer units in a buffer table.

10. The method of claim 9, wherein the buffer unit information includes offset information and size information associated with each one of the allocated buffer units.

11. The method of claim 10, further comprising:
storing error information associated with the uncorrectable data unit in the buffer table.

12. A system comprising:
a nonvolatile memory device; and
a memory controller configured to control execution of a read operation directed to read data stored in the nonvolatile memory device, wherein the read data includes a plurality of data units, each of the plurality of data units is identified as one of a correctable data unit and an uncorrectable data unit, the data of the uncorrectable data unit being uncorrectable using a normal error correction operation,
the memory controller being further configured to perform the normal error correction operation on the at least one correctable data unit of the plurality of data units to generate partial read data, communicate dummy data instead of the at least one uncorrectable data unit along with the partial read data to the host, and perform an enhanced error correction operation on the at least one uncorrectable data unit while at least in part the dummy data and partial data are being communicated from the memory controller to the host.

13. The system of claim 12, wherein the memory controller is further configured to communicate a corrected version of the at least one uncorrectable data unit to the host upon completion of the enhanced error correction operation.

14. The system of claim 13, wherein the dummy data is data selected from a group consisting of; data of the at least one uncorrectable read unit, data having a random pattern, and data having a predetermined pattern.

15. The system of claim 12, wherein the memory controller comprises a buffer memory and is further configured to allocate buffer units of the buffer memory to receive the plurality of data units of the read data, and store each one of the plurality of data units in a respective one of the allocated buffer units.

16. The system of claim 15, wherein the memory controller comprises an error correction coding (ECC) circuit and is further configured on a data unit-by-data unit basis for
the plurality of data units stored in the allocated buffer units to identify whether data associated with each one of the plurality of data units is correctable data.

17. The system of claim 16, wherein the identifying of whether data associated with each one of the plurality of data units is correctable data is performed using the normal error correction operation as executed by the ECC circuit.

18. The system of claim 12, wherein the memory controller comprises a buffer memory and is further configured to allocate buffer units, store the at least one correctable data unit, which is corrected an error by the normal error correction operation, in the allocated buffer units.

19. An operating method for a memory controller, comprising:
receiving a first command from host identifying a first read operation directed to first read data stored in a nonvolatile memory device, the first read data including a correctable data unit and an uncorrectable data unit, wherein the uncorrectable data unit contains data that is uncorrectable using a normal error correction operation;
receiving a second command from the host identifying a second read operation directed to second read data stored in the nonvolatile memory device;
performing the normal error correction operation on the correctable data unit of the first read data to generate partial read data;
communicating dummy data instead of the uncorrectable data unit along with the partial read data from the memory controller to a host; and
performing an enhanced error correction operation on the uncorrectable data unit while at least in part executing the second read operation.

20. The operating method of claim 19, further comprising:
allocating buffer units in a buffer memory of the memory controller to receive a plurality of data units of the first read data;
storing each one of the plurality of data units in a respective one of the allocated buffer units; and
on a data unit-by-data unit basis for the plurality of data units stored in the allocated buffer units, using an error correction coding (ECC) circuit to identify whether data associated with each one of the plurality of data units is correctable data using the normal error correction operation as executed by the ECC circuit.
